(19) United States
(12) Patent Application Publication
(10) Pub. No.: US 2006/0135126 A1
(43) Pub. Date: Jun. 22, 2006

(54) Data synchronization control method between a user equipment and a user authentication card and a corresponding user authentication card

(75) Inventors: Sang-Jin Lee, Seoul (KR); Ho-Kyung Sun, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/263,441

(22) Filed: Oct. 31, 2005

(30) Foreign Application Priority Data
Dec. 21, 2004 (KR) 10-2004-109933

(51) Int. Cl. H04M 1/66

(52) U.S. Cl. 455/411

(57) ABSTRACT

Disclosed is a user authentication card and a method for preventing data synchronization from being performed if information stored in the user authentication card is the same as that stored when a corresponding user equipment (UE) is powered off. The user authentication card includes a memory area for storing an electronic serial number of a UE, a memory area for storing a command defined for requesting the UE to transmit the electronic serial number and a memory area for storing a command defined for requesting transmission of the stored electronic serial number to the UE. A data synchronization method with a user authentication card in a UE capable of recognizing the user authentication card includes determining whether the user authentication card is recognized when the UE is powered on, reading an electronic serial number from the user authentication card and the read electronic serial number coincides with an electronic serial number of the UE, if it is determined that the user authentication card is recognized and controlling data synchronization to be performed only when it is determined that the two electronic serial numbers do not coincide with each other.

### PRIORITY

This application claims priority under 35 U.S.C. §119 to an application entitled “Data Synchronization Control Method Between UE And User Authentication Card And Corresponding User Authentication Card” filed in the Korean Intellectual Property Office on Dec. 21, 2004 and assigned Serial No. 2004-109933, the contents of which are incorporated herein by reference.

### BACKGROUND OF THE INVENTION

1. Field of the Invention

The present invention relates to a user authentication card and a User Equipment (UE) for recognizing the user authentication card, and more particularly to a data synchronization control method between a UE and a user authentication card and the user authentication card according to the method.

2. Description of the Related Art

When a mobile phone employing a Universal Mobile Telecommunication System (UMTS) scheme or a Global System for Mobile communication (GSM) scheme is powered on with a Subscriber Identity Module (SIM) card, a Universal Subscriber Identity Module (USIM) card or a Removable User Identity Module (RUIM) card inserted into the mobile phone, the mobile phone reads subscriber information from the inserted card, determines if a user is the correct user, and performs data synchronization. Typically, a card (e.g., the SIM card, the USIM card or the RUIM card) is mounted in a cardholder of the mobile phone. The SIM card, the USIM card or the RUIM card as described above are examples of user authentication cards. In addition, a mobile phone is also only an example of a UE using a user authentication card. That is, there are many other types of UEs embodying various other types of user authentication cards. When a UE using a user authentication card is powered on, the UE performs initialization. This initialization refers to initialization of the UE and the user authentication card and must be differentiated from initialization of the UE itself During this initialization, the UE passes through a reset process, an Answer to Reset (ATR) process and a Protocol Parameter Selection (PPS) process in order to exchange information with the user authentication card. The initialization is performed to determine physical interface environments between the UE and the user authentication card. Further, the UE does not exchange commands and responses with the user authentication card until the initialization is ended.

The initialization of the UE also includes data synchronization between the UE and the user authentication card. The data synchronization is conventionally performed unconditionally whenever the UE is powered on. That is, the UE reads all information of the user authentication card and compares the read information with information stored in the UE. As the situation requires, the UE modifies the information stored therein.

Hereinafter, the data synchronization between the UE and the user authentication card will be described using a SIM card as an example.

The SIM card as well as a mobile phone using the SIM card may also have a phone book. Accordingly, when the mobile phone is initialized, it is possible to read both the phone book of the SIM card and the phone book of the mobile phone and generate a new phone book by means of a sorting algorithm . When it is assumed that the phone book of the mobile phone can store data for 1000 persons and each data can store five phone numbers, 5000 phone numbers at maximum may exist in the phone book. Further, in a case where it is assumed that the phone book of the SIM card also stores 250 phone numbers, when the mobile phone is powered on after the SIM card is inserted into the mobile phone, 5000 phone numbers are individually compared with the 250 phone numbers for sorting.

Accordingly, performing the data synchronization unconditionally as described above may be very inefficient. That is, a Central Processing Unit (CPU) may perform unnecessary operations if the synchronization does not have to be performed which can waste time and system resources. Accordingly, there is a need to conditionally perform data synchronization dependent upon whether a user identification card has been removed from a UE.

### SUMMARY OF THE INVENTION

Accordingly, the present invention has been made to solve the above-mentioned problems occurring in the prior art and provides a method for preventing data synchronization from being performed if information stored in a user authentication card is the same as that stored when a corresponding UE is powered off, and the user authentication card according to the method.

According to a first object of the present invention, there is provided an apparatus and a method for performing data synchronization conditionally based on the following conditions. For example, if the mobile phone is powered off and then powered on in a state where the SIM card has remains coupled to the mobile phone, a synchronization including a phone book comparison can be omitted because data in the SIM card has not been changed. However, if the SIM card is uncoupled from the mobile phone and then reinserted therein in a state where the mobile phone has been powered off, the comparison must be performed. Accordingly, whenever a mobile phone is powered on in a state where the SIM card has been inserted therein, data synchronization is performed according to predefined conditions.

According to a second object of the present invention there is provided a method for registering an electronic serial number of a UE in a user authentication card in order to prevent data synchronization from being performed, if information stored in the user authentication card is the same as that stored when the corresponding UE is powered off.

According to third object of the present invention, there is provided a data synchronization method in a User Equipment (UE) including a user authentication card, the UE capable of recognizing the user authentication card, the method including determining whether the user authentication card is recognized when the UE is powered on, reading an electronic serial number from the user authentication card and determining whether the read electronic serial number coincides with an electronic serial number of the UE when the user authentication card is recognized, and controlling data synchronization to be performed only when the two electronic serial numbers do not coincide with each other.

According to a fourth object of the present invention, there is provided a user authentication card including a memory area for storing an electronic serial number of a User Equipment (UE), a memory area for storing a command defined for requesting the UE to transmit the electronic serial number and a memory area for storing a command defined for requesting transmission of the stored electronic serial number to the UE.

According to a fifth object of the present invention, there is provided a method for storing information of a User Equipment (UE) in a user authentication card, the method including requesting by the user authentication card for the UE to transmit an electronic serial number when the UE is powered on, transmitting by the UE the electronic serial number to the user authentication card in response to the request and receiving and storing by the user authentication card the electronic serial number.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a user equipment (UE) including a user authentication card according to an embodiment of the present invention;

FIG. 2 is a flow diagram illustrating a process by which a user authentication card requests a UE to transmit an electronic serial number of the UE, and receives and stores the requested electronic serial number, according to an embodiment of the present invention; and

FIG. 3 is a flow chart illustrating a process by which a UE determines if data synchronization with a user authentication card must be performed, according to an embodiment of the present invention.

### DETAILED DESCRIPTION OF THE PREFERRED EMBODIMENT

Hereinafter, a preferred embodiment according to the present invention will be described in detail with reference to the accompanying drawings. In the following description, particular items, such as detailed types of a user authentication card, are shown, but these are provided for aiding the general understanding of the present invention. Therefore it will be understood by those skilled in the art that the present invention can be realized without these particular items. In describing the present invention, a detailed description of known functions and configurations incorporated herein will be omitted when it may make the subject matter of the present invention unclear.

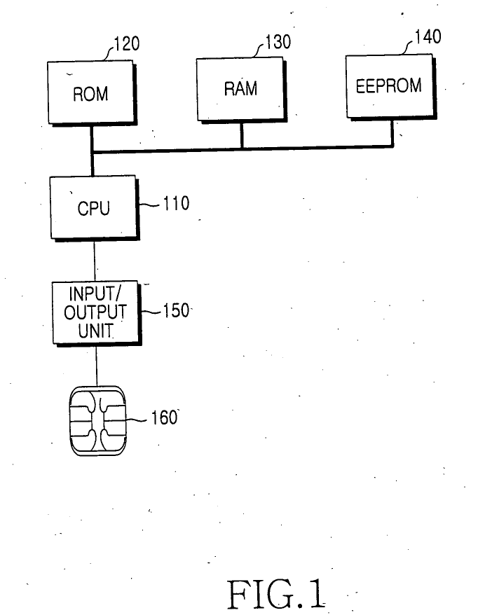

FIG. 1 is a block diagram illustrating the construction of a user authentication card according to an embodiment of the present invention. The user authentication card includes a contact unit 160, an input/output unit 150, a central processing unit (CPU) 110, a read-only memory 120, a random-access memory (RAM) 130 and an electronically erasable programmable read-only memory (EEPROM) 140.

The input/output unit 150 inputs data and/or commands from a user equipment (UE) or outputs data and/or commands to the UE through the contact unit 160. A contact type card requires physical contact with an external device in order to obtain power and clock signals for an operation of a chip. The contact unit 160 includes a plurality of terminals for power Vcc, a clock CLK, a reset RST, input/output I/O, etc. It is assumed that the present embodiment is applied to the contact type card. However, in an alternative embodiment a non-contact type card can also be used.

The Read Only Memory (ROM) 120 stores an operating system for the user authentication card.

The Random Access Memory (RAM) 130 is a temporary storage space and may include memory areas according to an embodiment of the present invention. That is, the RAM 130 may include a memory area for storing an electronic serial number of the UE, a memory area for storing a command defined for requesting the UE to transmit the electronic serial number and a memory area for storing a command defined for requesting the user authentication card to provide the stored electronic serial number to the UE. The memory area for storing the electronic serial number of the UE may be embodied in the form of a cyclic elementary file. The cyclic elementary file a space for storing a terminal's own ID and is one of a plurality of fields capable of storing data in an authentication card. Herein, multiple electronic serial numbers (ESNs) may be stored according to their use history, but a number to be compared is limited to only the electronic serial number of a most recently used UE. In other words, when the UE requests transmission of the stored electronic serial number, the electronic serial number of the most recently used UE must be provided from among the stored electronic serial numbers.

The Electrically Erasable Programmable Read-Only Memory (EEPROM) 140 is a memory for application storage. When it is assumed that the user authentication card is a Subscriber Identity Module (SIM) card, the EEROM 140 may store a phone book for storing phone numbers of subscribers.

The Central Processing Unit (CPU) 110 reads a command for requesting an electronic serial number from a corresponding memory area, and transmits the read command for requesting an electronic serial number to the UE. That is, when a command for requesting transmission of the stored electronic serial number is received from the UE, the CPU 110 recognizes the received command, reads the requested electronic serial number from a corresponding memory area and transmits the read electronic serial number to the UE.

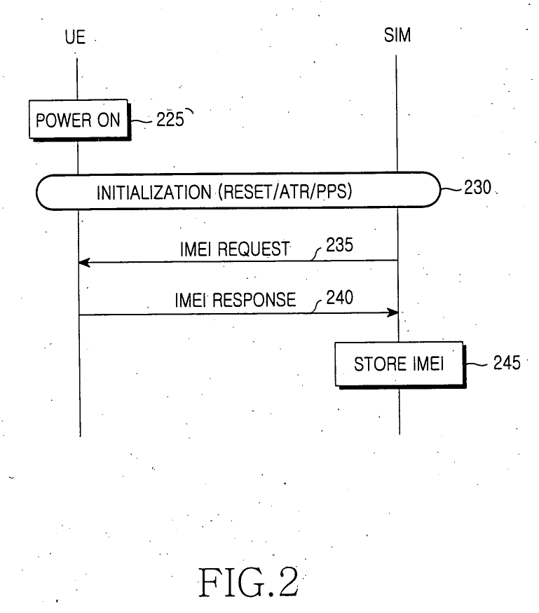

FIG. 2 is a flow diagram illustrating a process by which the user authentication card requests the UE to transmit an electronic serial number of the UE, and receives and stores the requested electronic serial number, according to a preferred embodiment of the present invention.

When the UE is powered on (step 225), a series of reset, Answer-to-Reset (ATR) and Protocol Parameter Selection (PPS) operations are performed between the user authentication card (e.g., a SIM) and the UE (step 230).

The CPU 110 of the user authentication card requests the UE to transmit an electronic serial number through the input/output unit 150 (step 235). When it is assumed that the UE employ a Global System for Mobile communication (GSM) scheme, the electronic serial number may be an International Mobile Station Equipment Identity (IMEI).

The UE transmits its own electronic serial number to the user authentication card in response to the request (step 240). The CPU 110 of the user authentication card stores the electronic serial number of the LIE received through the input/output unit 150 in a corresponding memory area (step 245).

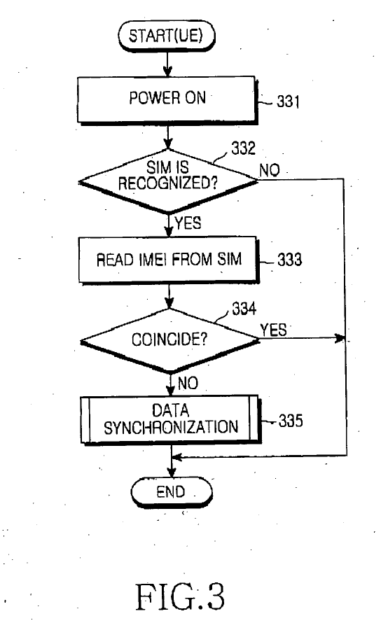

FIG. 3 is a flow chart illustrating a process by which the LIE determines if data synchronization with the user authentication card must be performed, according to a preferred embodiment of the present invention.

When the UE is powered on (step 331), the UE determines whether the user authentication card is recognized (step 332). If the user authentication card is recognized, the UE reads an electronic serial number from the user authentication card (step 333); After reading the electronic serial number, the UE determines whether the read electronic serial number coincides with an electronic serial number of the UE (step 334). In the present embodiment, the electronic serial number becomes an IMEI because the user authentication card is assumed to be a SIM.

As a result of the determination in step 334, if it is determined that the two electronic serial numbers coincide with each other, it is determined that it is not necessary to perform the data synchronization. Accordingly, the UE controls the data synchronization to be performed only when the two electronic serial numbers do not coincide with each other (step 335).

According to the present invention as described above, because a user authentication card stores an electronic serial number of a UE having most recently used the user authentication card, the electronic serial number stored in the user authentication card is checked when the UE is initialized. Therefore, it is possible to determine whether data synchronization with the user authentication card is required. Consequently, unnecessary operations can be omitted thus saving time and conserving system resources.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A user authentication card comprising:
a memory area for storing an electronic serial number (ESN) of a User Equipment (UE);
a memory area for storing a command for requesting the UE to transmit the electronic serial number; and
a memory area for storing a command for requesting transmission of the stored electronic serial number to the UE.

2. The user authentication card as claimed in claim 1, wherein the memory areas are included in a Random Access Memory (RAM).

3. The user authentication card as claimed in claim 1, further comprising a Central Processing Unit (CPU) for:
reading the command for requesting the UE to transmit the electronic serial number and transmitting the read command to the UE;
recognizing the command for requesting the transmission of the stored electronic serial number to the UE, when the command is received from the UE; and
reading the requested electronic serial number and transmitting the read electronic serial number to the UE.

4. The user authentication card as claimed in claim 1, further comprising a memory area for storing a phone book.

5. The user authentication card as claimed in claim 4, further comprising an Electrically Erasable Programmable Read-Only Memory (EEPROM), wherein the memory area for storing the phone book is included in the EEPROM.

6. The user authentication card as claimed in claim 1, wherein the electronic serial number of the UE is stored in a cyclic elementary file.

7. A method for storing information of a User Equipment (UE) in a user authentication card, the method comprising the steps of:
requesting, by the user authentication card, the UE to transmit an electronic serial number (ESN) when the UE is powered on;
transmitting, by the UE, the electronic serial number to the user authentication card in response to the request; and
receiving and storing, by the user authentication card, the electronic serial number.

8. The method as claimed in claim 7, further comprising a step of performing a series of reset, Answer-to-Reset (ATR) and Protocol Parameter Selection (PPS) between the user authentication card and the UE before the electronic serial number is requested.

9. A data synchronization method with a user authentication card in a User Equipment (UE) capable of recognizing the user authentication card, the method comprising the steps of:
determining whether the user authentication card is recognized when the UE is powered on;
reading an electronic serial number (ESN) from the user authentication card and determining whether the read electronic serial number coincides with an electronic serial number of the UE, if it is determined that the user authentication card is recognized; and
controlling data synchronization to be performed only when the two electronic serial numbers do not coincide with each other.
